(19) United States
(12) Patent Application Publication
(10) Pub. No.: US 2024/0332653 A1
(43) Pub. Date: Oct. 3, 2024

(54) Integrated Bi-Directional DC-DC Converter for Current Control in Li-Ion Modular Battery Monoblocks

(71) Applicant: Textron Aviation Inc., Wichita, KS (US)

(72) Inventors: Kyle Dietz Tidball, Wichita, KS (US); Michael Louis Koonce, Wichita, KS (US)

(21) Appl. No.: 18/624,871

(22) Filed: Apr. 2, 2024

Related U.S. Application Data
(60) Provisional application No. 63/493,939, filed on Apr. 3, 2023.

(51) Int. Cl. H01M 10/46; H01M 10/42; H02J 7/00

(52) U.S. Cl. CPC H01M 10/46; H02J 7/00304; H02J 7/007182; H01M 2010/4271; H01M 2220/20; H02J 2207/10; H02J 2207/20; H02J 2207/30

(57) ABSTRACT

An apparatus for controlling a battery monoblock charge and discharge current comprising: a battery monoblock having a series stack of battery cells, a battery monoblock controller connected to the series stack of battery cells and connected to a monoblock current sensor, a first battery cell voltage sensor connected to the series stack of battery cells, a second battery cell voltage sensor connected to the series stack of battery cells, and a bi-directional DC/DC converter connected between the series stack of battery cells and the first battery cell voltage sensor and connected to the battery monoblock controller, wherein the bi-directional DC/DC converter controls a charge or a discharge of the battery monoblock.

### CROSS-REFERENCE TO RELATED APPLICATIONS

This application claims the benefit of priority of U.S. Provisional Patent Application No. 63/493,939, entitled Integrated Bi-Directional DC-DC Converter for Current Control in Li-Ion Modular Battery Monoblocks, filed Apr. 3, 2023, the disclosure of which is herein incorporated by reference in its entirety.

### BACKGROUND

### 1. Field

This invention is generally in the field of power conversion and relates specifically to rechargeable lithium-ion batteries.

### 2. Related Art

Some Lithium-Ion battery cells have very high specific power and are capable of quite large charge and discharge current rates due to their extremely low internal resistance. However, in many applications it may be desirable to limit current allowed into or out of the battery. Known methods of current limiting are largely dissipative in nature, and not suitable for the magnitude of charge and discharge currents that may be achieved with a high specific power Li-Ion battery monoblock.

U.S. Patent Application No. 2017/0012452 to Kang et al. describes a bi-directional DC/DC converter which is resonant and the use of a two-phase interleaving technique to reduce input current ripple, output voltage ripple, and reduce conduction loss.

U.S. Pat. No. 11,108,333 to Feng et al. describes a DC/DC power convertor which includes a first pair of input/output lines for connecting to a first device for supplying power to or drawing power from the first device, and a second pair of input/output lines for supplying power to or drawing from a second device. The system in Feng requires at least one ultra-capacitor connected across the first pair of input/output lines.

U.S. Pat. No. 10,389,166 to Sahoo et al. describes a dual active bridge (DAB) converter as well as a single-stage AC-DC converter where the DC-DC portion is a subsystem. Sahoo describes a control scheme for controlling voltage only while charging a battery.

U.S. Pat. No. 9,595,873 to Zane et al. describes a system that implements a dual active bridge (DAB) converter and a series resonant converter.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In certain aspects, an apparatus for controlling a battery monoblock charge and discharge current includes: a battery monoblock having: a series stack of battery cells; a battery monoblock controller connected to the series stack of battery cells and connected to a monoblock current sensor; a first battery cell voltage sensor connected to the series stack of battery cells; a second battery cell voltage sensor connected to the series stack of battery cells; and a bi-directional DC/DC converter connected between the series stack of battery cells and the first battery cell voltage sensor and connected to the battery monoblock controller, wherein the bi-directional DC/DC converter controls a charge or a discharge of the battery monoblock.

In certain aspects, a method for controlling a battery monoblock charge and discharge current includes the steps of: providing an apparatus including: a battery monoblock having: a series stack of battery cells; a battery monoblock controller connected to the series stack of battery cells and connected to a monoblock current sensor; a first battery cell voltage sensor connected to the series stack of battery cells; a second battery cell voltage sensor connected to the series stack of battery cells; and a bi-directional DC/DC converter connected between the series stack of battery cells and the first battery cell voltage sensor and connected to the battery monoblock controller, wherein the bi-directional DC/DC converter controls a charge or a discharge of the battery monoblock; sensing a bus voltage with the monoblock controller; determining if the bus voltage is higher or lower than a target threshold; and charging the battery monoblock if the bus voltage is higher that the target threshold or discharging the battery monoblock if the bus voltage is lower than the target threshold.

In certain aspects, an apparatus for controlling a battery charge and discharge current includes: a battery comprising a plurality of battery monoblocks each having: a series stack of battery cells; a battery monoblock controller connected to the series stack of battery cells and connected to a monoblock current sensor; a first battery cell voltage sensor connected to the series stack of battery cells; a second battery cell voltage sensor connected to the series stack of battery cells; and a bi-directional DC/DC converter connected between the series stack of battery cells and the first battery cell voltage sensor and connected to the battery monoblock controller, wherein the bi-directional DC/DC converter controls a charge or a discharge of the battery monoblock; and a battery controller configured to control an overall current limit of the battery by independently adjusting a current limit of each monoblock via its battery monoblock controller.

### BRIEF DESCRIPTION OF THE DRAWING FIGURES

Embodiments of the invention are described in detail below with reference to the attached drawing figures, wherein:

The drawing figures do not limit the invention to the specific embodiments disclosed and described herein. The drawings are not necessarily to scale, emphasis instead being placed upon clearly illustrating the principles of the invention.

FIG. 1 illustrates a schematic diagram with a bi-directional DC/DC converter integrated into the battery monoblock system.

FIG. 2 illustrates an optional configuration of the system without a contactor or relay in series with the battery cells, using the bi-directional DC/DC converter as the method of protection.

FIG. 3 illustrates one useful example topology for the bi-directional dc/dc converter employed in this system.

FIG. 4 illustrates an example topology for the bi-directional dc/dc converter employed in this system.

FIG. 5 illustrates an example topology for the bi-directional dc/dc converter employed in this system.

FIG. 6 illustrates an example of setting an initially higher charge current limit until the monoblock battery cells have reached a voltage threshold, and then setting a lower current limit for the remainder of the charging period.

FIG. 7 illustrates an example of dynamically adjusting the current limit in response to the electrical load of an aircraft.

FIG. 8 illustrates an example of setting the current limit to maintain an average current.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Batteries are a common device for the storage of energy for use in a variety of industries and may vary from providing small energy storage levels to large energy storage levels. As the energy levels increase, the battery will increase in a number of cells within the battery, the cells being the storage units of energy. Lithium-ion batteries are common, particularly for use with aircraft, and use lithium ions as a component of electrochemistry for power storage.

The modular battery monoblock system of the instant invention utilizes a bi-directional DC/DC converter integrated into the modular battery monoblock, specifically for limiting current into and out of the modular battery monoblock. The monoblock controller may provide varying charge and discharge schedules based on factors such as the number of monoblocks installed on an aircraft, the maximum power the generator or power source is capable of providing, and external signals outside of the monoblock, etc. The ability to control the current limits reduces stress on the generator or power source as well as the battery monoblock cells, which allows for longer lifetime and increased reliability.

By arranging the cells within the battery monoblock into a high-voltage series string of cells and integrating a bi-directional, high-efficiency, DC/DC converter into the battery monoblock, current into and out of the battery monoblock may be controlled and regulated. By regulating the battery monoblock current, stress on the cells may be significantly reduced during recharging after a deep battery discharge, or extremely high discharge current demand (e.g., engine start).

Additionally, by limiting monoblock charging current, load on the aircraft generator is reduced. Limiting generator load is necessary on aircraft that have no generator load regulation to protect the generator from going into overcurrent protection and removing itself from the aircraft bus, causing a loss of electrical power to the aircraft.

Furthermore, by arranging lower specific power cells in a high voltage configuration and converting the monoblock voltage down to a lower aircraft bus voltage while limiting the cell discharge current, similar power delivery may be achieved compared to high specific power cells in a lower voltage monoblock without current regulation. This enables construction of a battery from a much broader choice of cells.

The instant invention provides a method and apparatus for controlling a battery monoblock charge and discharge current by means of a battery monoblock integrated bi-directional dc/dc converter. The invention introduces several novel features:
1) incorporation of a bi-directional dc/dc converter into a battery monoblock.
2) built-in battery monoblock charge and discharge current regulation.
3) the ability to eliminate the monoblock contactor or relay.
4) the ability to choose a different current regulation limit for charge and discharge.
5) minimization of stress on the power source by synchronization and scheduling charge of a system with N installed monoblocks.

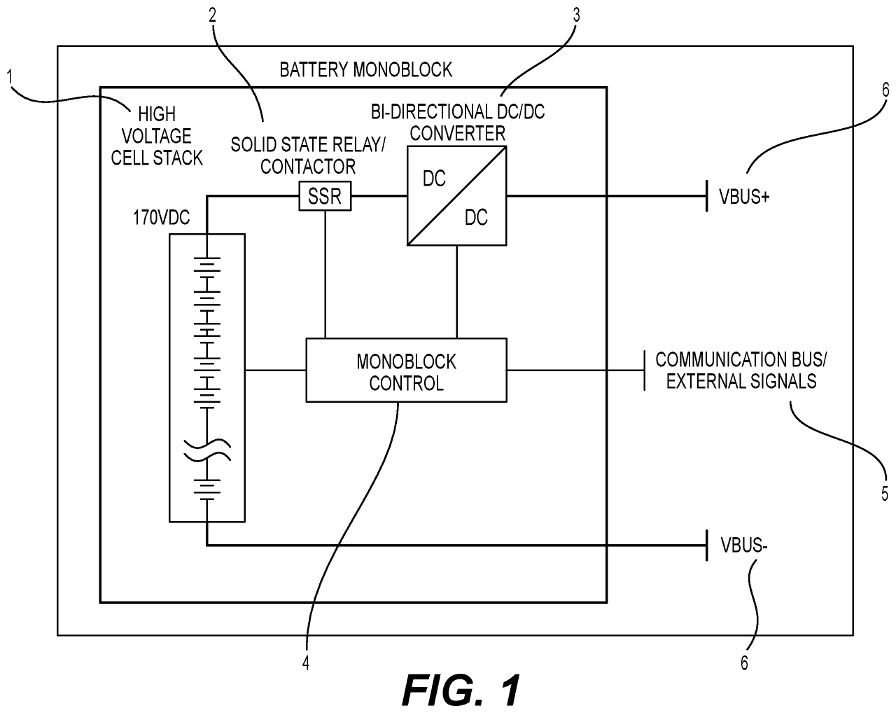

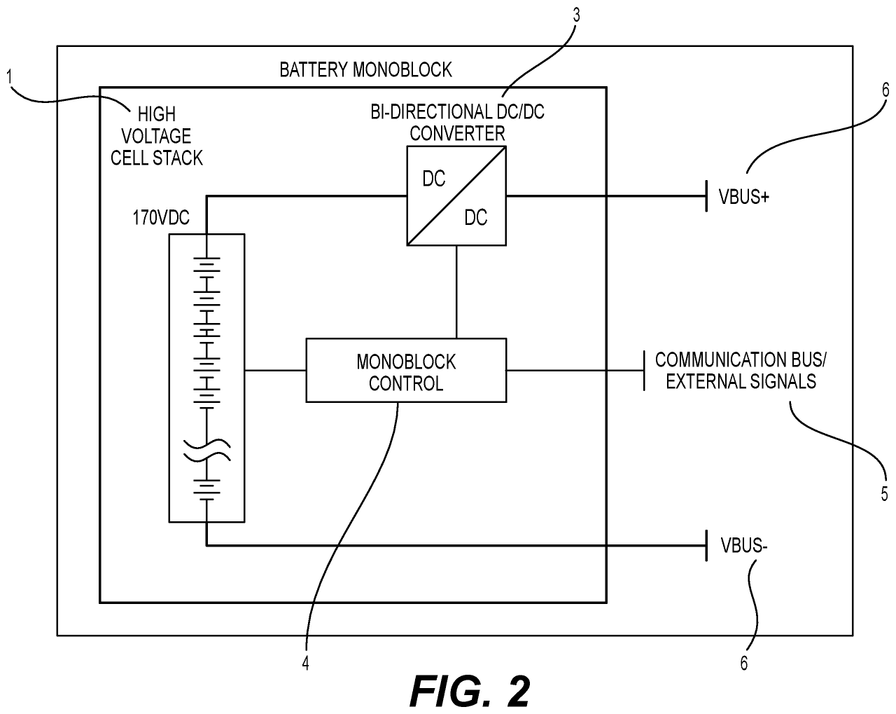

Referring to the figures, where like numerals refer to like elements, there is illustrated embodiments of schematic diagrams, example topologies, and plots. FIG. 1 shows a schematic diagram with a bi-directional DC/DC converter integrated into the battery monoblock system. FIG. 2 shows an optional configuration of the system without a contactor or relay in series with the battery cells, using the bi-directional dc/dc converter as the method of protection. The components of the Integrated Battery Monoblock Bi-directional DC/DC Converter system illustrated in FIGS. 1 and 2 include:
1) a “high-voltage” series stack of battery cells
2) an optional internal monoblock contactor or relay
3) a bi-directional DC/DC converter
4) a battery monoblock controller
5) a monoblock current sensor
6) battery cell voltage sensors

When the bus voltage becomes lower than a target threshold, under normal operating conditions, the battery monoblock will be discharged. The bi-directional DC/DC converter will convert the sum of the voltage of the high voltage series string of battery cells to a pre-configured, constant monoblock output voltage (e.g., 26.4 VDC). During this conversion time, the bi-directional DC/DC converter will also regulate the allowed output current from the monoblock and limit the current to no more than the discharge regulation set point, allowing the monoblock output voltage to sag to maintain the maximum regulated current.

When the bus voltage becomes higher than a target threshold set in the monoblock controller's software, under normal operating conditions, the battery monoblock will be charged. The bi-directional DC/DC converter will convert the aircraft bus voltage to a pre-configured charging voltage and apply a constant voltage to the series string of battery cells. During this charging time period, the bi-directional DC/DC converter will limit the current delivered to the battery cells to no more than the charge regulation set point defined in the battery monoblock controller's software. Different charge profiles, such as constant current-constant voltage (CC-CV), could also be implemented. The CC-CV method includes a period of time during which the cell is charged at constant current until a voltage threshold is reached. Once this threshold is reached, the cell is charged at constant voltage for the remainder of the charge cycle.

In addition, during the monoblock battery cell charging time period, the bi-directional DC/DC converter may be controlled in such a way so as to allow an initially higher charging current, potentially allowing the bi-directional DC/DC converter's charging voltage to be lowered, until the monoblock's series battery stack voltage reaches a pre-configured voltage threshold, at which time the bi-directional dc/dc converter may lower the charge current regulation limit and charge the series battery stack at a constant voltage.

The specific topology of the power converter is not critical, and a number of common topologies may be suitable for use in this application. The limiting factor is simply that the converter realized is capable of bi-directional DC power and regulation of current, including down to zero current flow in either direction.

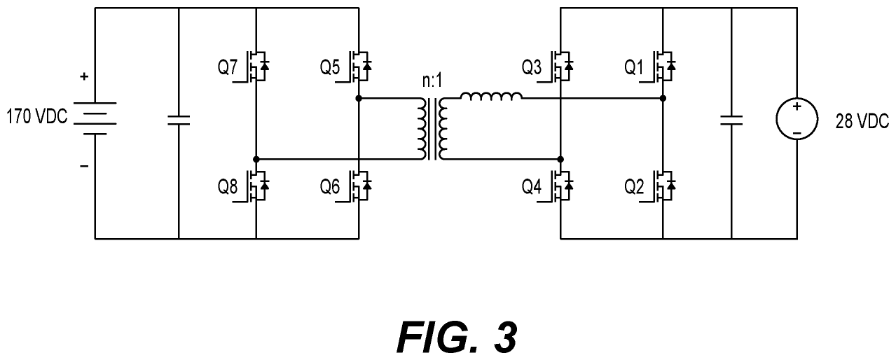

FIG. 3 illustrates one useful example topology for the bi-directional DC/DC converter employed in this system. This topology is known as a Dual Active Bridge (DAB), and transfers power either from input (28 VDC) to output (170 VDC battery), or vice versa, by manipulating the phase shift between the two bridge rectifiers, with up to +50% phase shift in either direction. The DAB may be controlled with a cascaded control loop system, consisting of an outer voltage control loop to regulate output voltage, and an inner current control loop to regulate current. This enables limits on the maximum current sourced in either direction. The following two equations aid in determining the phase shift:

$${P}_{transfered} = \frac{{V}_{in} {V}_{out}}{2 {π}^{2} {f}_{s} {L}_{k}} δ ( 1 - δ )$$

This equation shows the relationship between power transferred from one side of the DAB to the other (primary to secondary), where fs is switching frequency, Lk is transformer leakage inductance, and delta is the phase shift between Vᵢₙ and Vₒᵤₜ.

φ=δπ

In this equation, delta is derived from the phase angle between the voltage on the primary and secondary sides of the transformer, represented by phi, limited to ±pi/2.

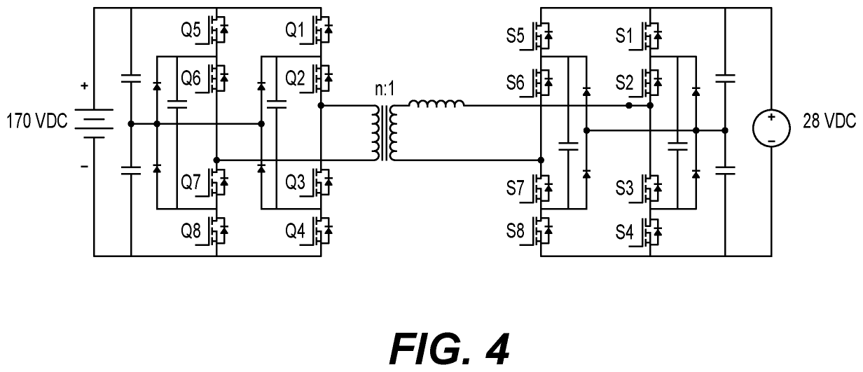

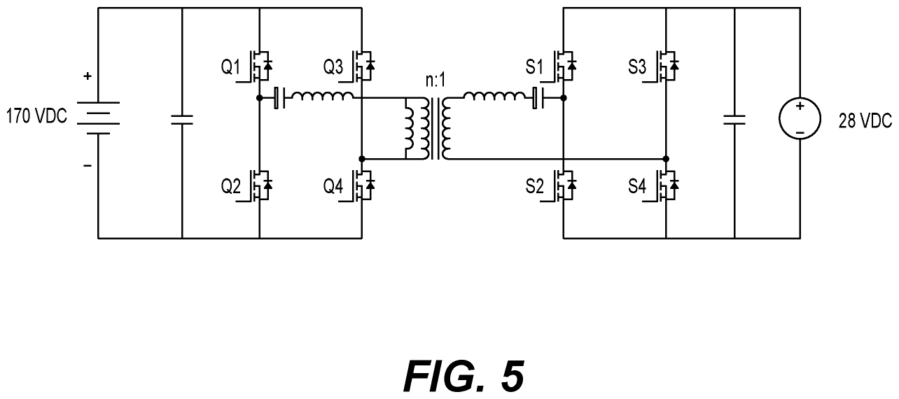

This method is directly realizable by any power converter topology capable of bi-directional DC operation. FIGS. 4 and 5, for example, provide two additional topologies that are suitable. FIG. 4 shows a 3-Level Dual Active Bridge, which operates on a similar principle to the DAB discussed above for FIG. 3, but, in some applications, may provide higher efficiency by reducing voltage stress across the switching devices. In multi-level converter topologies, the full DC link voltage is no longer present across each switch. Rather, a fraction of the voltage, proportional to the number of levels (i.e., 3-level divides the voltage seen on each switch by 2, etc.) is present across each switch. This means there is a smaller voltage present across each switch, which 1) allows the selection of a lower voltage rated part, which may reduce switching and conduction losses or 2) with higher voltage rated switches, inherently reducing the maximum voltage seen across the switch, reducing voltage stress, and reducing switching loss. Likewise, series resonant converter topologies may be employed in yet another variant of this application. FIG. 5 illustrates an example of a series resonant converter. Any type of bi-directional DC/DC converter may be utilized in this application because the regulation of current is the primary function of the converter.

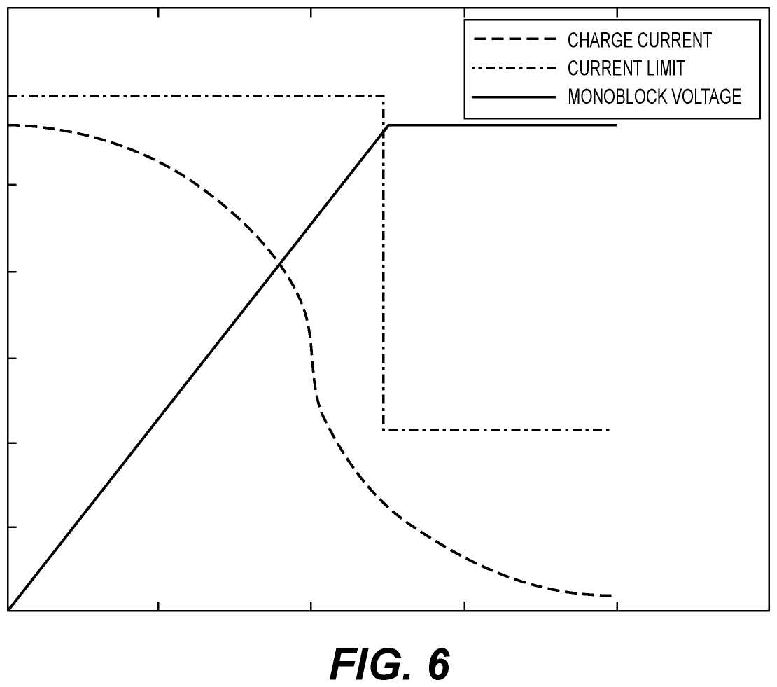

The monoblock controller may provide a control signal to the DC/DC converter to indicate in which direction it should transfer power, (i.e. if the battery is “charging” or “discharging,”) or if there has been fault (e.g. overvoltage, overtemperature, etc.) and the converter should stop switching and disconnect the monoblock from the bus to protect the monoblock battery cells. The monoblock controller will include both software and hardware—i.e., a printed circuit board with a microcontroller that includes software for controlling the device. The monoblock controller will have programming instructions to respond to a change in the voltage level of the aircraft bus and charge the battery or discharge it appropriately. The monoblock controller may also command different current limits to the dc/dc converter. FIG. 6 illustrates an example of setting an initially higher charge current limit until the monoblock battery cells have reached a voltage threshold, and then setting a lower current limit for the remainder of the charging period. This may be achieved either manually (e.g., the crew can flip a cockpit switch to toggle between preset current limits) or as an automated (programming instructions) process.

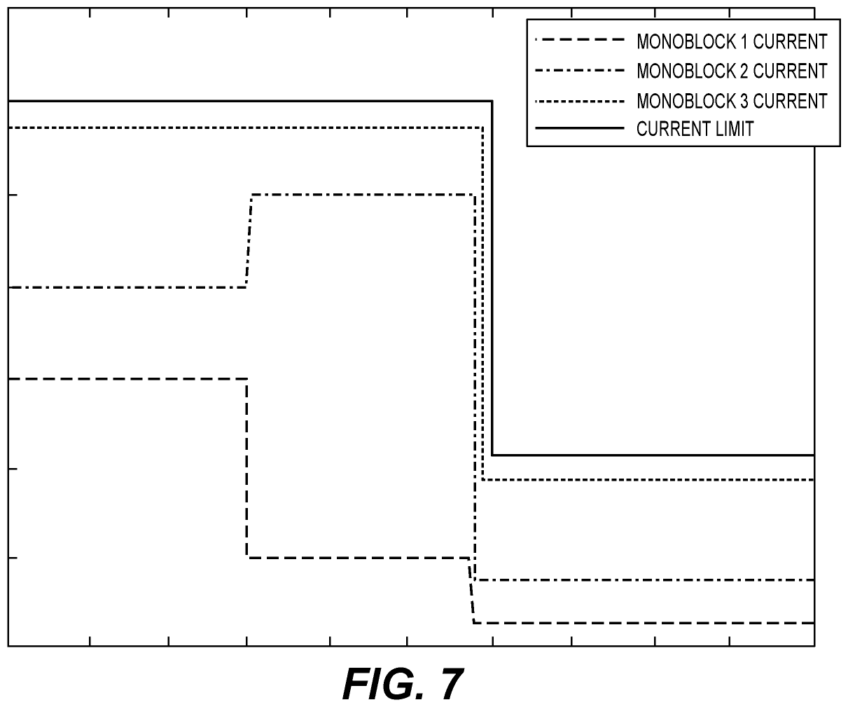

In addition, the overall current limit of the battery system may be adjusted dynamically in response to the electrical load on the aircraft. Since each monoblock current limit can be independently controlled or synchronized, the limit of all monoblocks installed can be adjusted such that an average load current is maintained, but each monoblock is allowed a different current limit as necessary. FIG. 7 shows an example of this method.

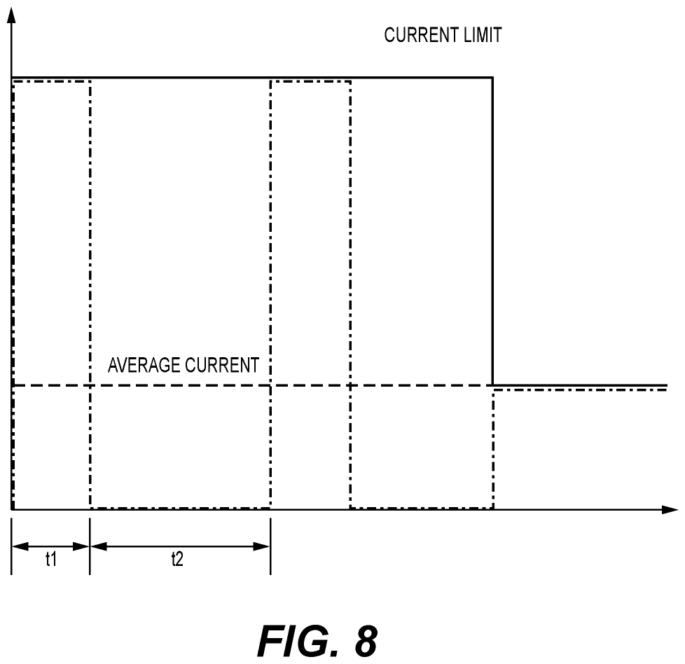

In a scenario where there may be many monoblocks installed, it may be desirable to synchronize and schedule the charging of each monoblock. This may be accomplished by setting a lower current limit for all monoblocks (i.e. current limit/n) to maintain an average load current for all monoblocks, or by allowing a higher than normal charge current limit, for a single monoblock, for a period of time (t1), then disabling charging for another period of time (t2) and repeating until the monoblocks are charged to a predetermined level, at which point the load stress on the power source is no longer critical. FIG. 8 shows an example of setting the current limit to maintain an average current. This would be achieved using an additional software module (e.g., a battery system controller) that can be separate from the monoblock, residing and executed elsewhere in the aircraft system.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An apparatus for controlling a battery monoblock charge and discharge current comprising:
a battery monoblock having:
a series stack of battery cells;
a battery monoblock controller connected to the series stack of battery cells and connected to a monoblock current sensor;
a first battery cell voltage sensor connected to the series stack of battery cells;
a second battery cell voltage sensor connected to the series stack of battery cells; and
a bi-directional DC/DC converter connected between the series stack of battery cells and the first battery cell voltage sensor and connected to the battery monoblock controller,
wherein the bi-directional DC/DC converter controls a charge or a discharge of the battery monoblock.

2. The apparatus of claim 1, wherein the series stack of battery cells is a high voltage series stack of battery cells.

3. The apparatus of claim 1 further comprising an internal monoblock contactor or relay connected between the series stack of battery cells and the bi-directional DC/DC converter, and connected to the battery monoblock controller.

4. The apparatus of claim 1, wherein a current regulation limit for charging and discharging are independent of one another.

5. The apparatus of claim 1, wherein the bi-directional DC/DC converter is configured to convert a sum of a voltage of the series stack of battery cells to a pre-configured, constant monoblock output voltage.

6. The apparatus of claim 1, wherein one or more of the apparatus are installed on an aircraft.

7. The apparatus of claim 6, wherein the bi-directional DC/DC converter is configured to convert an aircraft bus voltage to a pre-configured charging voltage and apply a constant voltage to the series stack of battery cells for a charging time period.

8. The apparatus of claim 7 wherein the bi-directional DC/DC converter is configured to limit the current delivered to the series stack of battery cells to no more than a charge regulation set point defined in a battery monoblock controller's software.

9. A method for controlling a battery monoblock charge and discharge current comprising the steps of:
providing an apparatus including:
a battery monoblock having:
a series stack of battery cells;
a battery monoblock controller connected to the series stack of battery cells and connected to a monoblock current sensor;
a first battery cell voltage sensor connected to the series stack of battery cells;
a second battery cell voltage sensor connected to the series stack of battery cells; and
a bi-directional DC/DC converter connected between the series stack of battery cells and the first battery cell voltage sensor and connected to the battery monoblock controller,
wherein the bi-directional DC/DC converter controls a charge or a discharge of the battery monoblock;
sensing a bus voltage with the monoblock controller;
determining if the bus voltage is higher or lower than a target threshold; and
charging the battery monoblock if the bus voltage is higher than the target threshold or discharging the battery monoblock if the bus voltage is lower than the target threshold.

10. The method of claim 9 wherein the series stack of battery cells is a high voltage series stack of battery cells.

11. The method of claim 9 further comprising an internal monoblock contactor or relay connected between the series stack of battery cells and the bi-directional DC/DC converter, and connected to the battery monoblock controller.

12. The method of claim 9 wherein a current regulation limit for charging and discharging are independent of one another.

13. The method of claim 9 comprising the bi-directional DC/DC converter converting a sum of a voltage of the series stack of battery cells to a pre-configured, constant monoblock output voltage.

14. The method of claim 9 wherein one or more of the apparatuses are installed on an aircraft.

15. The method of claim 14, comprising the bi-directional DC/DC converter converting an aircraft bus voltage to a pre-configured charging voltage and applying a constant voltage to the series stack of battery cells for a charging time period.

16. The method of claim 15 comprising the bi-directional DC/DC converter limiting the current delivered to the series stack of battery cells to no more than a charge regulation set point defined in a battery monoblock controller's software.

17. An apparatus for controlling a battery charge and discharge current comprising:
a battery comprising a plurality of battery monoblocks each having:
a series stack of battery cells;
a battery monoblock controller connected to the series stack of battery cells and connected to a monoblock current sensor;
a first battery cell voltage sensor connected to the series stack of battery cells;
a second battery cell voltage sensor connected to the series stack of battery cells; and
a bi-directional DC/DC converter connected between the series stack of battery cells and the first battery cell voltage sensor and connected to the battery monoblock controller,
wherein the bi-directional DC/DC converter controls a charge or a discharge of the battery monoblock; and
a battery controller configured to control an overall current limit of the battery by independently adjusting a current limit of each monoblock via its battery monoblock controller.

18. The apparatus of claim 17 wherein a current limit of each of the monoblocks is adjusted to deliver an average load current as requested by the battery controller while the current limit of each monoblock differs as needed.

19. The apparatus of claim 18, wherein the average load current requested by the battery controller is delivered by adjusting a current limit based on time, such that the current limit for a first time period is different than for a second time period.

20. The apparatus of claim 17, wherein each battery monoblock controller is configured to command a maximum current limit to the dc/dc converter until a voltage threshold of the monoblock is met, followed by a lower current limit.
